(19) United States
(12) Patent Application Publication
(10) Pub. No.: US 2006/0058128 A1
(43) Pub. Date: Mar. 16, 2006

(54) Belt-driven conical-pulley transmission, method for producing it, and motor vehicle having such a transmission

(75) Inventor: Ronald Glas, Achern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/208,035

(22) Filed: Aug. 20, 2005

Related U.S. Application Data
(60) Provisional application No. 60/662,437, filed on Mar. 16, 2005.

(30) Foreign Application Priority Data
Aug. 24, 2004 (DE) 10 2004 040 826.2
Aug. 28, 2004 (DE) 10 2004 041 715.6
Sep. 4, 2004 (DE) 10 2004 042 883.2
Sep. 9, 2004 (DE) 10 2004 043 536.7
Sep. 14, 2004 (DE) 10 2004 044 190.1
Sep. 22, 2004 (DE) 10 2004 046 213.5

(51) Int. Cl. F16H 55/56; F16H 63/00

(52) U.S. Cl. 474/8; 474/28

(57) ABSTRACT

An automatic transmission in the form of a belt-driven conical pulley transmission having input side and output side pairs of conical disks. An endless torque-transmitting member extends between the pairs of conical disks for transmitting torque between the input side disks and the output side disks. The strand natural frequency of the endless torque-transmitting member is permanently adjustable to minimize strand vibrations that can cause undesired noise.

### CROSS-REFERENCE TO RELATED APPLICATION

This application claims the benefit of U.S. Provisional Application Ser. No. 60/662,437, filed on Mar. 16, 2005.

### BACKGROUND OF THE INVENTION

1. Field of the Invention

The present invention relates to an automatic transmission in the form of a belt-driven conical-pulley transmission, as known for example from DE 10 2004 015 215 and other publications, as well as a method for producing it and a motor vehicle equipped with it.

2. Description of the Related Art

Automatic transmissions in the broader sense are converters, whose momentary transmission ratio changes automatically, in steps or continuously, as a function of present or anticipated operating conditions, such as partial load and coasting, and environmental parameters, such as, for example, temperature, air pressure, and, humidity. They include converters that are based on an electrical, pneumatic, hydrodynamic, or hydrostatic principle, or on a principle which is a mixture of those principles.

The automation refers to a great variety of functions, such as start-up, choice of transmission ratio, or the type of transmission ratio change in various operating situations, where the type of transmission ratio change can mean, for example, shifting to different gear steps in sequence, skipping gear steps, and the speed of shifting.

The desire for convenience, safety, and reasonable construction expense determines the degree of automation, i.e., how many functions take place automatically.

As a rule, the driver can intervene manually in the automatic sequence, or can limit it for individual functions.

Automatic transmissions in the narrower sense, as they are used today primarily in the construction of motor vehicles, usually have the following structure:

On the input side of the transmission there is a start-up unit in the form of a regulatable clutch, for example a wet or dry friction clutch, a hydrodynamic clutch, or a hydrodynamic converter.

With a hydrodynamic converter or a hydraulic coupling, often a bridging clutch or lock-up clutch is connected parallel to the pump and turbine parts, which increases the efficiency by transferring the force directly and damps vibrations through defined slippage at critical rotational speeds.

The start-up unit drives a mechanical, continuously variable or stepped, multi-speed gearbox, which can include a forward/reverse driving unit, a main group, a range group, a split group, and/or a variable speed drive. Gearbox groups can be of intermediate gear or planetary design, with straight or helical tooth system, as a function of the requirements in terms of quietness of operation, space conditions, and transmitting options.

The output element of the mechanical transmission, a shaft or a gear, drives a differential directly or indirectly via intermediate shafts or an intermediate stage with constant transmission ratio, which can be configured as a separate gearbox or is an integral component of the automatic transmission. In principle, the transmission is suitable for longitudinal or transverse installation in the motor vehicle.

To adjust the transmission ratio in the mechanical transmission there are hydrostatic, pneumatic, and/or electrical actuators. A hydraulic pump, which operates on the displacement principle, supplies oil under pressure for the start-up unit, in particular the hydrodynamic unit, for the hydrostatic actuators of the mechanical transmission, and for lubricating and cooling the system. As a function of the necessary pressure and delivery volume, possibilities include gear pumps, screw pumps, vane pumps and piston pumps, the latter usually of radial design. In practice, gear pumps, vane pumps, and radial piston pumps have come to predominate for that purpose, with gear pumps and vane pumps offering advantages because they are less expensive to build, and the radial piston pump offering advantages because of its higher pressure level and better regulation ability.

The hydraulic pump can be located at any desired position in the transmission, on a main or a secondary shaft that is constantly driven by the drive unit.

Continuously variable automatic transmissions are known that consist of a start-up unit, a reversing planetary gearbox as the forward/reverse drive unit, a hydraulic pump, a variable speed drive, an intermediate shaft and a differential. The variable speed drive, in turn, consists of two pairs of conical disks and an endless torque-transmitting means. Each pair of conical disks includes a second conical disk that is movable in the axial direction. Between those pairs of conical disks passes the endless torque-transmitting means, for example a steel thrust belt, a tension chain, or a drive belt. Moving the second conical disk changes the running radius of the endless torque-transmitting means, and thus the transmission ratio of the continuously variable automatic transmission.

Continuously variable automatic transmissions (CVT) require a high level of pressure in order to be able to move the conical disks of the variable speed drive with the desired speed at all operating points, and also to transmit the torque with a sufficient base contact pressure with minimum wear.

In motor vehicles the need for comfort and convenience is generally very high, especially in regard to the noise level. The driver and passengers, especially in upscale vehicles, want there to be no disturbing noises coming from the operation of the vehicle's mechanical units. But the internal combustion engine, and also other mechanical units such as transmissions, does produce sounds, which can be widely perceived as disturbing. Thus, for example, in continuously variable transmissions where a plate-link chain is used there can be a sound, since such a plate-link chain, because of its construction with plate links and pins, produces a recurring impact due to the pins striking the conical disks of the transmission. In CVT transmissions, acoustic effects are generally attributed to the pin impact as the source. That acoustic excitation then produces resonances at the natural frequencies of the transmission housing (FE modes) or of the shafts (torsional modes, bending modes).

Another acoustic effect is produced by the CVT belt, the CVT band, or the CVT chain, which can vibrate on the tension side like a musical string; that can be suppressed for example by a slide bar. Torsional friction vibrations at frequencies of 10 Hz are known in clutches, for example, as grabbing. If the coefficient of friction gradient is such that the coefficient of friction decreases with increasing relative rotational speed or velocity, as the slippage changes grabbing results. In automatic transmissions it is primarily the steel-to-paper coefficient of friction that is relevant.

### SUMMARY OF THE INVENTION

Part of the purpose of the present invention is to improve the acoustics of such a transmission, and thus to improve the comfort—in particular the sound comfort—of a motor vehicle equipped with such a transmission. Another part of the purpose of the present invention is, after analyzing strong CVT vibrations and clarifying the associated operating mechanisms, to design appropriate countermeasures for minimizing—or if possible preventing—those vibrations, which lie for the most part in the acoustic range on the order of 400-600 Hz. Another part of the purpose of the present invention is to increase the endurance strength of components, and thus to prolong the operating life of such an automatic transmission. The reason for another part of the purpose of the present invention is to increase the torque transmission capability of such a transmission and to be able to transmit greater forces through the components of the transmission. Furthermore—hence that is another part of the purpose—it should be possible to economically produce such a transmission.

The parts of the problem are solved by the invention along with its refinements, presented in the claims and in the description, and are explained in connection with the drawing figures.

The analysis produces a simulation-based understanding of the nature of the vibration form, which involves a movement of the encircling chain coupled with a tipping or bending of the particular conical disk. The primary determinants of the frequency of the vibrations are the mass of the chain and the overall tipping and bending stiffness of the conical disks. That stiffness includes the inherent dishing of the disks, the tipping of the disks, the bending of the shafts as a result of their elasticity, and the tilt of the shafts as result of differences in bearing rigidities or bearing spacings. In addition, the coefficient of friction level and the gradient of the coefficient of friction, as well as the rotational speed and the transmission ratio, are determinants of the frequency.

Those findings are surprising, inasmuch as vibrations of the chain in the encircling arc, i.e., while it is being clamped in the disk set, have not been described before, and are also contrary to the view held heretofore that the frictional contact with the conical disks suppresses such vibrations in the arcs.

The influence of the CVT oil on such frictional vibrations has also not been described before, so that up until now those oils have been developed merely for friction that is high and is stable over time, as well as for low wear.

While it is known that with the movable CVT conical disks (movable disks) tilting play between the shaft and the movable disk has an effect on the efficiency, no vibrational bending, tilting, or wobbling motions of the movable disks have been described heretofore.

In the case of CVT transmissions in the form of belt-driven conical-pulley transmissions having an endless torque-transmitting means, in particular a chain, the conical disks of the variable speed drive are distorted by the clamping forces acting against the endless torque-transmitting means. Those clamping forces are necessary on the one hand in order to prevent slippage of the chain when transmitting torque, and on the other hand to set and change the transmission ratio of the variable speed drive and hence of the transmission. At the same time, the shape of the wedge-shaped gap that the conical disk halves form is changed under load. Considering the shaping of the conical disks and the position of the corresponding load application points of the endless torque-transmitting means, the wedge-shaped gap is deformed most severely from the non-loaded position when the load resulting from the clamping force against the endless torque-transmitting means is greatest and the corresponding force application points are located farthest out radially, i.e., at the greatest possible diameter. In the case of a CVT in the form of a belt-driven conical-pulley transmission, the force application points of the endless torque-transmitting means or chain or steel thrust belt are decisively determined by the transmission ratio of the variable speed drive. In addition, it must be kept in mind that the force application points do not act on the conical disks around the entire 360° circumference, but only in an angular range that is limited by the corresponding transmission ratio and hence is smaller. That results in asymmetrical dishing of the pulley halves, as will be explained later.

Because of that non-uniform dishing and the non-uniform load distribution within the endless torque-transmitting means, a radial motion in the direction of the center of the shaft is forced on the endless torque-transmitting means as it runs through the loop on the pulley. That is also influenced by the direction of rotation, since the circumstances depend upon whether the segment of chain under consideration is part of the loaded strand or of the slack strand. An outwardly directed relative movement also at least partially takes place at the conical disks, while the wedge gap closes somewhat again because of the conical disk deformation starting from the largest expansion in the loop to the outlet.

The greater the load, the more pronounced the occurrence of those deformations and the greater the friction forces and friction paths that develop as a result. The friction results in lost efficiency and wear, and also acts as an exciting mechanism for frictional vibrations. The frictional vibrations, in turn, can produce noises, for example through excitation of structure-borne noise.

The most critical case of the above-described effects for the design occurs at the pulleys on the output side of a belt-driven conical-pulley transmission when driving off. That is because the load from the drive unit is at a maximum when starting up, as is the clamping force on the endless torque-transmitting means due to the corresponding transmission ratio conversion to slow. Due to that conversion, the endless torque-transmitting means or chain is at its maximum outer radial position on the conical disks at the output side. Because of that load, the conical disks on the output side are severely deformed, or pressed apart very severely, so that the wedge-shaped gap becomes very large, resulting in maximum friction paths and friction forces.

Noise problems can also be caused, or amplified, by vibrations of the endless torque-transmitting means. For that reason, efforts should be made toward reducing, or better, totally eliminating, strand vibrations. In the case of the solutions that have thus far appeared, the strands run freely, from the time they exit one disk set to the time they enter the opposing disk set or conical disk pair. Virtually unhindered vibrations similar to those of vibrating strings can occur on those travel paths between the engagement components. Exclusively mechanical measures, in which, for example, guide rails or tensioners have been installed, have thus far been employed in order to reduce strand vibrations. However, such solutions merely limit the amplitudes of the vibrations involved, instead of counteracting their causes. Moreover, such solutions require employing additional components, which cause cost and lead to wear.

In accordance with the invention, another contribution to solving the problems at hand and improving state-of-the-art transmissions consists of a belt-driven conical-pulley transmission that has pairs of conical disks on its input side and at its output side, which each have an axially fixed disk and an axially movable disk that are arranged on an input shaft and an output shaft, respectively, and are interconnectable by an endless torque-transmitting means for transmitting torque, wherein the strand natural frequency of the endless torque-transmitting means is permanently adjusted, whereby there will no longer be any stationary operating points at which excitation of the resonance of the strand can be induced, e.g., a harmonic of the strand running frequency.

It can prove beneficial if that adjustment is generated by modulating a frequency by the contact pressure. That applies especially with systems having electronically controlled contact pressure.

It can prove beneficial if the modulation frequency does not lie in the region of the strand natural frequency.

That modulation frequency can lie below the strands natural frequency.

It can prove particularly beneficial if the adjustment of the strand natural frequency involves a synchronous modulation of the adjustment pressures of the pairs of input side and output side conical disk pairs.

In general, in the case of belt-driven conical pulley transmissions in accordance with the invention, it can prove beneficial to set the modulation frequency and/or the modulation amplitude so high that the adjustment gradient of the strand natural frequency prevents a vibration of the strand when passing through an excitation.

The invention also relates to a method for operating a belt-driven conical pulley transmission in accordance with the invention.

Further, another factor that contributes to solving the problem and to improving state-of-the-art transmissions is a belt-driven conical-pulley transmission having pairs of conical disks on the power input side and on the output side. The disk pairs each have a fixed disk and a movable disk that are positioned on respective shafts on the input side and the output side and are connectable by means of an endless torque-transmitting means. The running surfaces of the conical disk pairs that interact with the endless torque-transmitting means have an oriented structure.

At the same time it can be advantageous if the surface structure is introduced in a finishing process.

The finishing can thereby take place in one step or several steps, as well as also with different roughing bands or with different parameters, for example, feed pressure force and oscillations. Moreover, the structure can be brought about by sliding and finishing in single or multiple steps, as well as by rotating or hard turning and finishing, respectively, in single of multiple steps, or by hard turning and sliding and finishing, respectively, in single or multiple steps.

In general, it can be advantageous in the case of a belt-driven conical-pulley transmission in accordance with the present invention if an endless abrasive belt (a finishing band) is applied to form the structure.

It can be especially advantageous if the direction of motion of the abrasive belt relative to the running surface is directed similar to the motion of the endless torque-transmitting means relative to the running surface during operation.

The movement direction of the abrasion band can be arranged to be tangential to take into account the rotation direction, or also at an angle inclined to the tangential direction. Additionally, the movement direction can produce cross grinding, or the movement direction can be orbiting. It can also prove to be advantageous that the adjustment direction or the movement direction is incidentally to be carried out practically stochastically, without a predominant direction, such as is the case with shot peening or laser honing.

This measure also makes it possible to reduce the running-in wear of the chain or endless torque-transmitting means, since the scaling of the surface is favorably oriented right from the start.

In addition, it can be advantageous if the direction of adjustment of the abrasive belt corresponds to the direction of motion, whereby the adjustment can be continuous or timed.

It can prove to be especially advantageous if the running surface has a roughness R_{z} of from 1 to 5, especially R_{z} of from 2 to 4.5.

With a belt-driven conical-pulley transmission in accordance with the present invention it can be especially advantageous to provide carbon nitrided conical disks, for example to favorably influence the wear behavior. The conical disks can, however, also be unhardened, inductively hardened, case hardened, nitrided, nitrocarburized, carbonnitrided, coated, surface hardened, or fully hardened.

In general it can be advantageous if other processing steps occur in such a way that the direction of motion of the processing means relative to the running surface of the conical disk is similar in direction to the motion of the endless torque-transmitting means relative to the running surface, whereby the processing steps precede the finishing or replace the finishing, or can be directly opposed in connected processing steps so that processing scale can be broken.

In addition, a contribution is made to solving the problem and to improving transmissions that represent the state of the art. In that regard, for example, the four conical disks are of similar geometric design in regard to dish shape and rigidity. A belt-driven conical-pulley transmission is provided having pairs of conical disks on the power input side and on the output side, which each have a fixed disk and a movable disk, which are positioned respectively on shafts on the input side and on the output side, and are connectable by means of an endless torque-transmitting means, where the belt-driven conical-pulley transmission has a variable speed drive that is optimized for stiffness.

Another factor that contributes to solving the problem and to improving transmissions in accordance with the existing art is a belt-driven conical-pulley transmission having pairs of conical disks on the power input side and the output side which each have a fixed disk and a movable disk, which are positioned respectively on shafts on the input side and the output side, and are connectable by means of an endless torque-transmitting means. A slide seat of at least one movable disk is located in its radially inner area and at least one slide seat of at least one movable disk is located in its radially outer area.

With the slide seat arrangements close to the shaft, as shown also for example in FIG. 1 and in FIGS. 8a and 8b, the length of the entire disk set is determined in part by the length of the conical disk and the subsequent connected components, with the slide seats having an effect on the length of the conical disks. If one of the slide seats is shifted radially outwardly, the connected components that follow can be located under the slide seat, so that they lie radially within the radially-outwardly-positioned slide seat, which makes it possible to save axial construction space. In that space, radially inside of that slide seat, one can accommodate for example the mounting of the set of disks, a part of the housing with the rotating bushings for supplying fluid to the particular disk set, a hydraulic pump, or a drive unit for a hydraulic pump.

It is also possible, for example, to use the newly gained construction space in the interior area for a power-branched transmission of an all-wheel-drive arrangement.

It can be especially advantageous with a belt-driven conical-pulley transmission in accordance with the present invention, if the movable disk has two slide seats, while it can be advantageous, for example in regard to the stiffness, if the movable disk has three slide seats, as shown for example in FIG. 10 and described in that connection.

It can also be advantageous if, drawing on the slide seat located radially outwardly, a centrifugal oil cover is formed, whereby additional construction space can be gained, for example in the radially inner area.

In a belt-driven conical-pulley transmission in accordance with the present invention, the slide seat arrangement can be provided on the pair of conical disks on the power input side and/or on the output side.

Since the additionally necessary axial construction space length of the slide seat, because of a seal, the application of which lengthens the slide seat, is not determinative of the construction space, the slide seat located radially outward can be sealed by a seal that is located axially adjacent to it.

In general, it can be advantageous in a belt-driven conical-pulley transmission in accordance with the present invention to position the mounting of the movable disk radially inside of the radially-outwardly-arranged slide seat.

It can be advantageous, for example, in regard to production-friendly design, if the radially-outwardly-arranged slide seat is formed by using a component that is connected to the movable disk; wherein that connection can be a welded joint.

In addition, that component can be used to form a centrifugal oil cover, which can be used for rotational-speed-dependent centrifugal oil compensation; it is also possible to form two centrifugal oil chambers in order to achieve even greater centrifugal oil compensation.

It can be especially advantageous when a radially outward force is applied if the stiffness of the pair of disks on the output side is significantly greater than that on the power input side; it can prove to be advantageous if that stiffness is greater by a factor of 1.2 to 3.

It can also be advantageous if the movable disk on the output side is significantly stiffer than the movable disk on the power input side.

In a belt-driven conical-pulley transmission in accordance with the present invention, it can be advantageous if the conical disks on the output side have a geometrically significantly more massive conical disk dish than do the conical disks on the power input side.

In addition, it can be useful if the movable disk on the output side has a geometrically significantly more massive conical disk neck than does the movable disk on the power input side.

It can prove advantageous if the movable disk on the output side has a geometrically significantly more massive conical disk dish than does the fixed disk on the output side.

It can prove advantageous if the movable disk on the input side has a geometrically significantly more massive conical disk plate than the fixed disk on the input side.

It can also prove to be useful if the movable disk on the output side has a smaller average guidance free play than does the movable disk on the power input side.

In addition, it can be advantageous if the movable disk on the output side has a significantly longer, large guide seat than does the movable disk on the power input side.

It can be useful if at least one movable disk has at least one integrally formed sealing trace.

It can also be advantageous if at least one movable disk has two directly connected sealing traces.

It can be useful to produce the sealing trace with or without cutting metal, as a function of the construction form.

Furthermore, when the disks are in the condition of having been moved together, an open region can be provided beside the at least one sealing location, which can serve as a dirt collection space.

In a belt-driven conical-pulley transmission, it can be advantageous if the movable disk on the output side has a cylindrically-shaped conical disk neck, wherein the conical disk neck can serve for spring centering, and/or if the conical disk neck has a half-round groove can serve as a spring contact.

In general, it can be advantageous if the movable disk on the output side has a compression spring that lies radially far to the outside.

In addition, it can be advantageous if the movable disk on the output side has at least one applied sheet metal part that can serve as a sealing trace for at least one seal.

Depending, for example, on the construction of the variable speed drive, the spring can be of cylindrical, narrow waisted, or conical design.

In general, it can be advantageous if the fixed disk on the output side is significantly stiffer than the fixed disk on the power input side.

It can be especially advantageous if the variable speed drive is constructed in accordance with the dual piston principle, as described, for example, in DE 103 54 720.7.

To solve that problem, it can be necessary to consider more than one of the influenceable parameters, and thus for example to combine certain properties of the oil with certain mechanical configurations.

In accordance with the invention a solution of the problem can be contributed by a belt-driven conical-pulley transmission having pairs of conical disks on the input and output sides, each having a fixed disk and a movable disk, which are positioned in each case on shafts on the input side and on the output side, and are connectable by means of a endless torque-transmitting means for transmitting the torque, where at least one of the listed factors is optimized in terms of the acoustics of the transmission:
a viscous or hydraulic medium in the form of oil;
the surface quality of the contact regions between the conical disk and the endless torque-transmitting means;
the geometry of at least one conical disk;
the damping of at least one conical disk; and
the guidance of at least one conical disk.

It can be advantageous to use an oil having a coefficient of friction that is insensitive to the frictional speed. It can also be advantageous to optimize the contact surfaces between the conical disk and the endless torque-transmitting means, for example in regard to their topography.

Furthermore, it can be advantageous to provide at least one conical disk that is optimized for rigidity and/or at least one damped conical disk. It can also prove advantageous to integrate into the transmission at least one conical disk that is radially outwardly guided.

In addition, the present invention relates to a motor vehicle having a transmission in accordance with the invention.

### BRIEF DESCRIPTION OF THE DRAWINGS

The structure, operation, and advantages of the present invention will become further apparent upon consideration of the following description, taken in conjunction with the accompanying drawings in which:

FIG. 1 is a partial view of a belt-driven conical-pulley transmission;

FIG. 2 is an illustration of another embodiment, corresponding essentially to

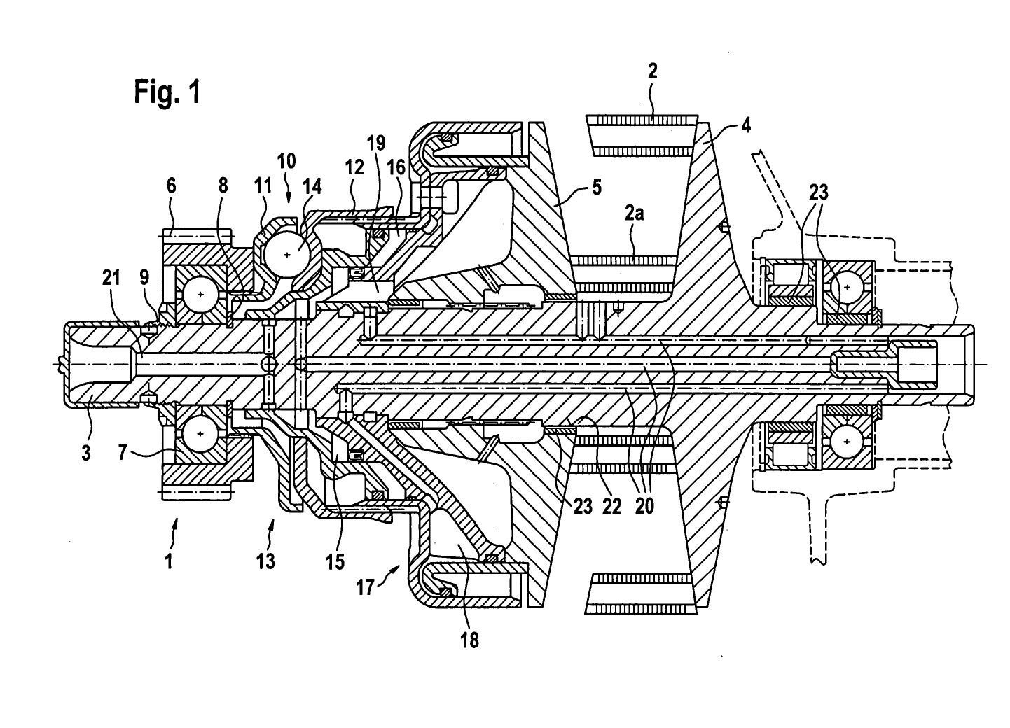

FIG. 1;

FIGS. 3 and 4 are graphs of correlations of coefficients of friction;

FIGS. 5 and 6 are schematic configuration possibilities for movable disks;

FIG. 7 shows schematically the asymmetrical cupping of a conical disk;

FIG. 8a shows a belt-driven conical-pulley transmission having geometrically similar sets of conical disks;

FIG. 8b shows a belt-driven conical-pulley transmission having sets of conical disks optimized for stiffness;

FIGS. 9 and 10 show exemplary embodiments of pairs of output side conical disks;

FIGS. 11 and 12 show input side conical disk sets;

FIG. 13 is an enlarged, fragmentary view of area XIII of FIG. 11;

FIG. 14 shows a set of output side conical disks;

FIG. 15 is an enlarged, fragmentary view of a portion of an output side movable disk;

FIG. 16 is a detail of a conical disk; and

FIG. 17 is a schematic view of a variable speed drive.

### DESCRIPTION OF THE PREFERRED EMBODIMENTS

FIG. 1 shows only a part of a belt-driven conical-pulley transmission, namely the input side of the belt-driven conical-pulley transmission 1, which is driven by a drive engine, for example an internal combustion engine. In a fully constructed belt-driven conical-pulley transmission, there is associated with the input-side part a complementarily designed output-side part of the continuously variable belt-driven conical-pulley transmission, the two parts being connected by an endless torque-transmitting means in the form of a plate-link chain 2, for example for transferring torque. Belt-driven conical-pulley transmission 1 has a shaft 3 on its input side, which is designed in the illustrated exemplary embodiment in a single piece with a stationary conical disk or fixed disk 4. In the axial longitudinal direction of shaft 3, that axially fixed conical disk 4 is positioned close to and opposite an axially displaceable conical disk or movable disk 5.

In the illustration according to FIG. 1, plate-link chain 2 is shown in a radial outer position on disk pair 4, 5 on the input side, resulting from the fact that the axially displaceable conical disk 5 is shifted toward the right in the drawing, and that shifting movement of axially displaceable conical disk 5 results in a movement of plate-link chain 2 in the radial outward direction, producing a change in the transmission ratio of the transmission toward greater speed.

Axially displaceable conical disk 5 can also be shifted to the left in the plane of the drawing in a known manner, where in that position plate-link chain 2 is in a radially inner position (which is given reference numeral 2a), producing a transmission ratio of belt-driven conical-pulley transmission 1 in the direction of a slower speed.

The torque provided by a drive engine, not shown in detail, is introduced into the input side part of the belt-driven conical-pulley transmission shown in FIG. 1 by way of a gear 6 mounted on shaft 3. Gear 6 is supported on shaft 3 by means of a roller bearing in the form of a ball bearing 7 that absorbs axial and radial forces, and which is set on shaft 3 by means of a washer 8 and a shaft nut 9. Between gear 6 and axially displaceable conical disk 5 is a torque sensor 10, with which a spreader disk configuration 13 having an axially fixed spreader disk 11 and an axially displaceable spreader disk 12 is associated. Located between the two spreader disks 11′ 12 are roller elements, for example in the form of the illustrated balls 14.

A torque introduced through gear 6 results in the formation of an angle of rotation between axially stationary spreader disk 11 and axially displaceable spreader disk 12, which results in an axial displacement of spreader disk 12 because of start-up ramps located on the latter, onto which the balls 14 run up, thus causing an axial offset of the spreader disks with respect to each other.

Torque sensor 10 has two pressure chambers 15, 16, of which first pressure chamber 15 is intended to be charged with a pressure medium as a function of the torque introduced, and second pressure chamber 16 is supplied with pressure medium as a function of the transmission ratio of the transmission.

To produce the clamping force that is applied as a normal force to plate-link chain 2 between axially stationary disk 4 and axially displaceable disk 5, a piston and cylinder unit 17 is provided which has two pressure chambers 18, 19. First pressure chamber 18 changes the pressure on plate-link chain 2 as a function of the transmission ratio, and second pressure chamber 19 serves in combination with torque-dependent pressure chamber 15 of torque sensor 10 to increase or reduce the clamping force that is applied to plate-link chain 2 between conical disks 4, 5.

To supply pressure medium, shaft 3 has three conduits 20, through which pressure medium is fed into the pressure chambers from a pump, which is not shown. The pressure medium is able to drain from shaft 3 through a drain conduit 21 on the outlet side, and can be conducted back to the circuit.

Applying pressure to pressure chambers 15, 16, 18, 19 results in a torque-dependent and ratio-dependent shifting of axially displaceable conical disk 5 on shaft 3. To seat shiftable conical disk 5, shaft 3 has centering surfaces 22, which serve as a sliding fit for displaceable conical disk 5.

As can be readily seen from FIG. 1, in the bearing regions of conical disk 5 on shaft 3, belt-driven conical-pulley transmission 1 has a respective sound damping device 23. For that purpose the sound damping device can have a ring body and a damping insert, or it can consist only of a damping insert.

The reference numerals used in FIG. 1 also refer to the essentially comparable features of the other figures. Thus the figures are to be regarded as a unit in that respect. For the sake of clarity, only the reference numerals that go beyond those in FIG. 1 are used in the other figures.

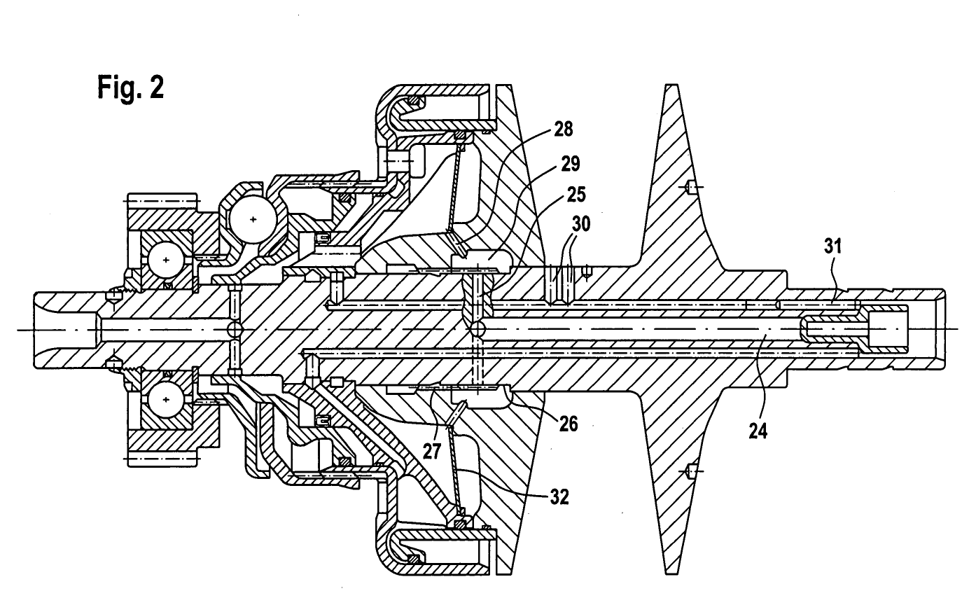

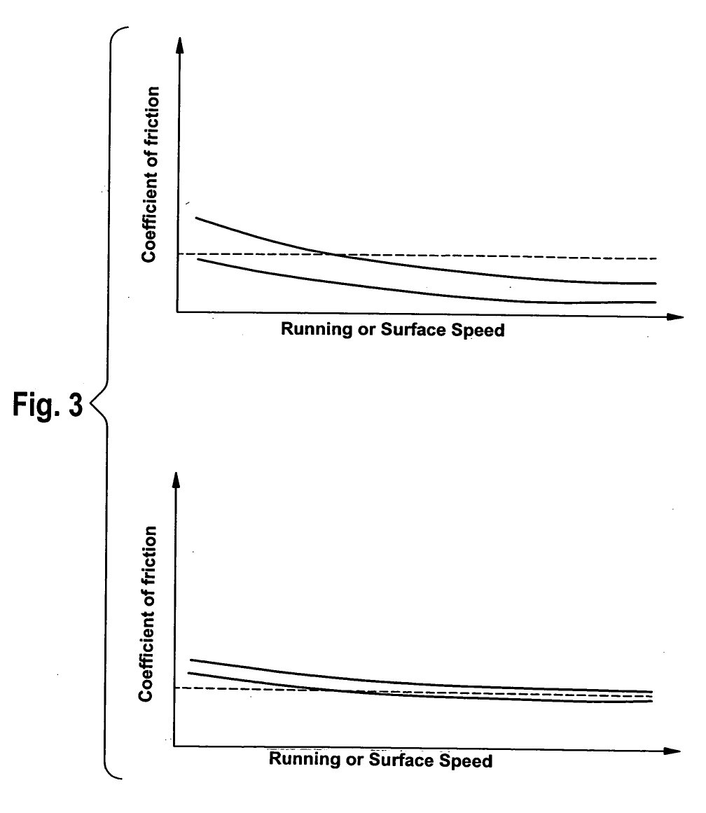

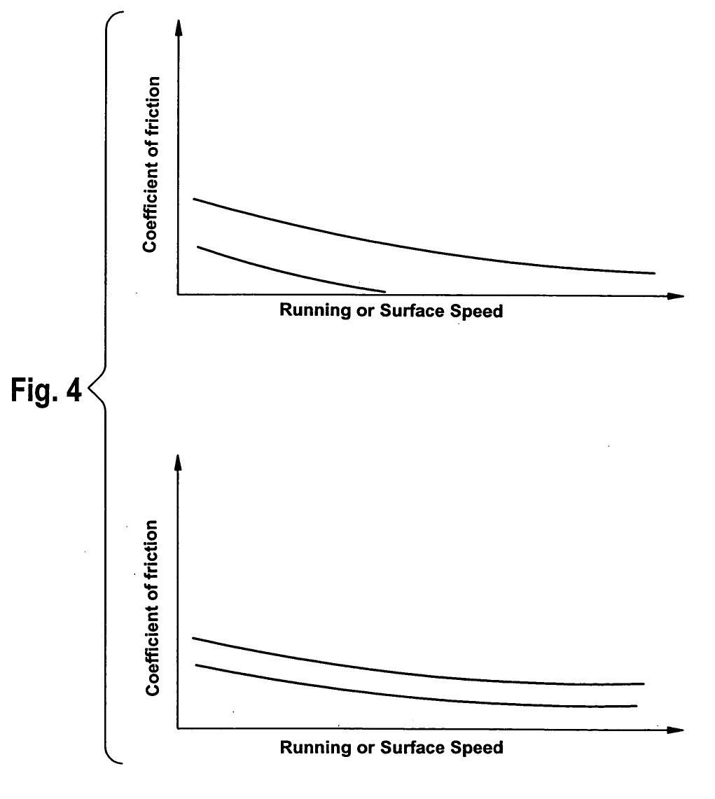

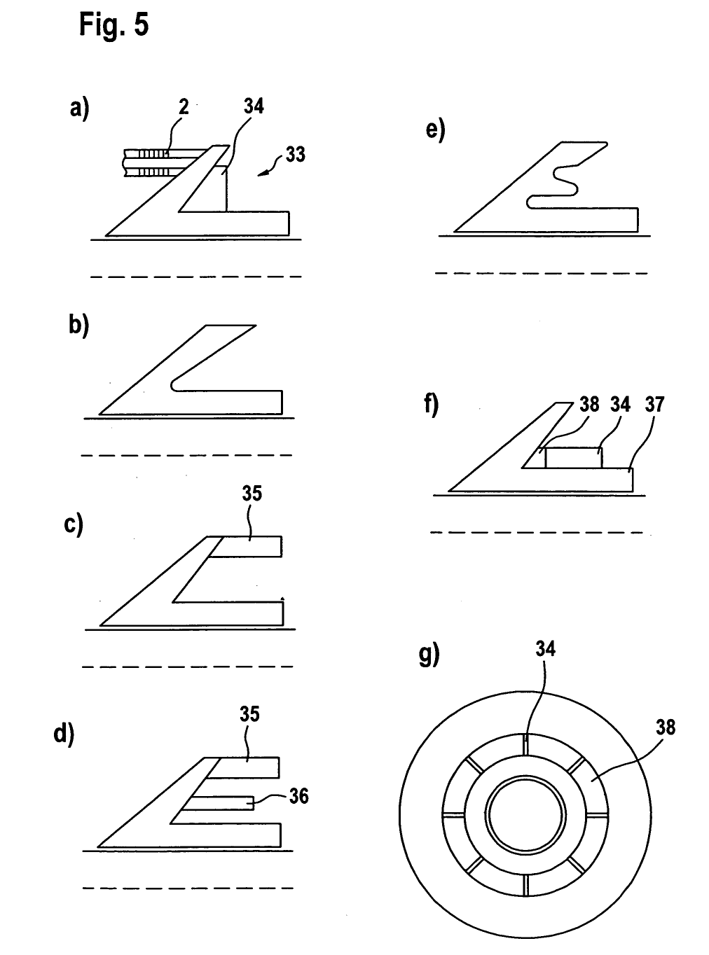

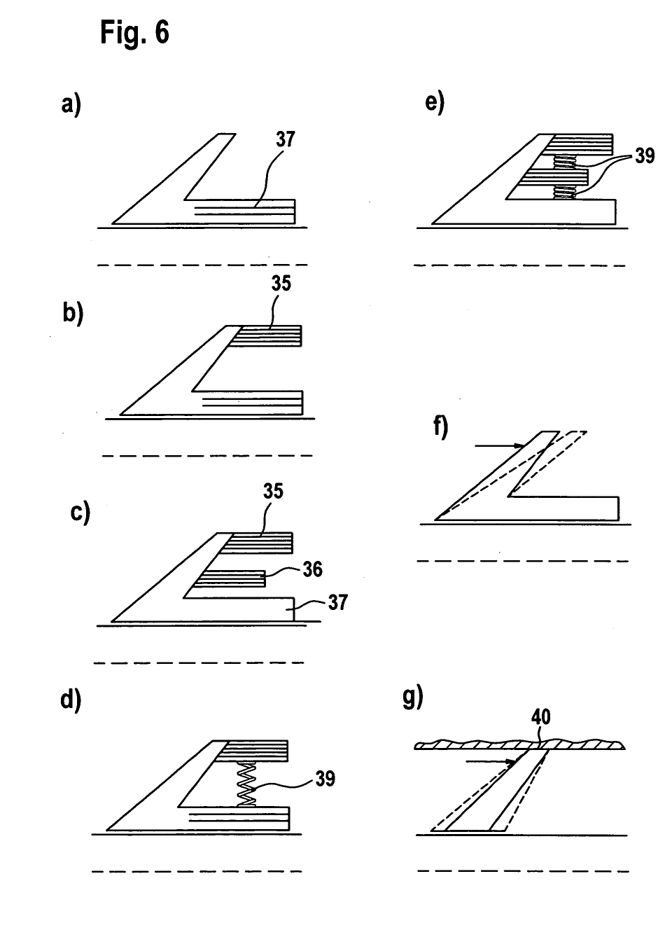

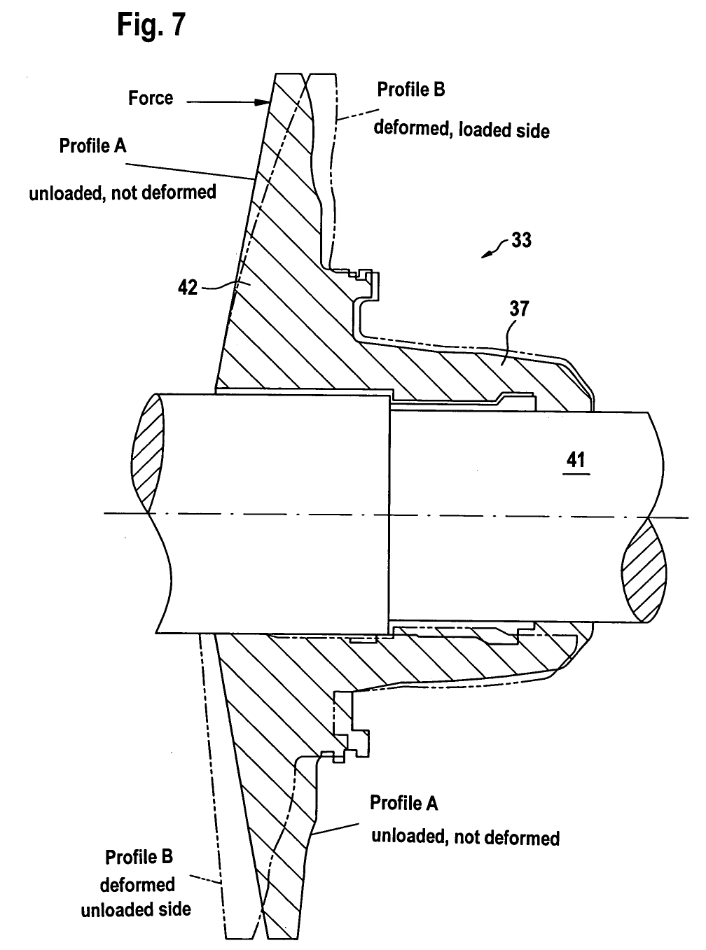

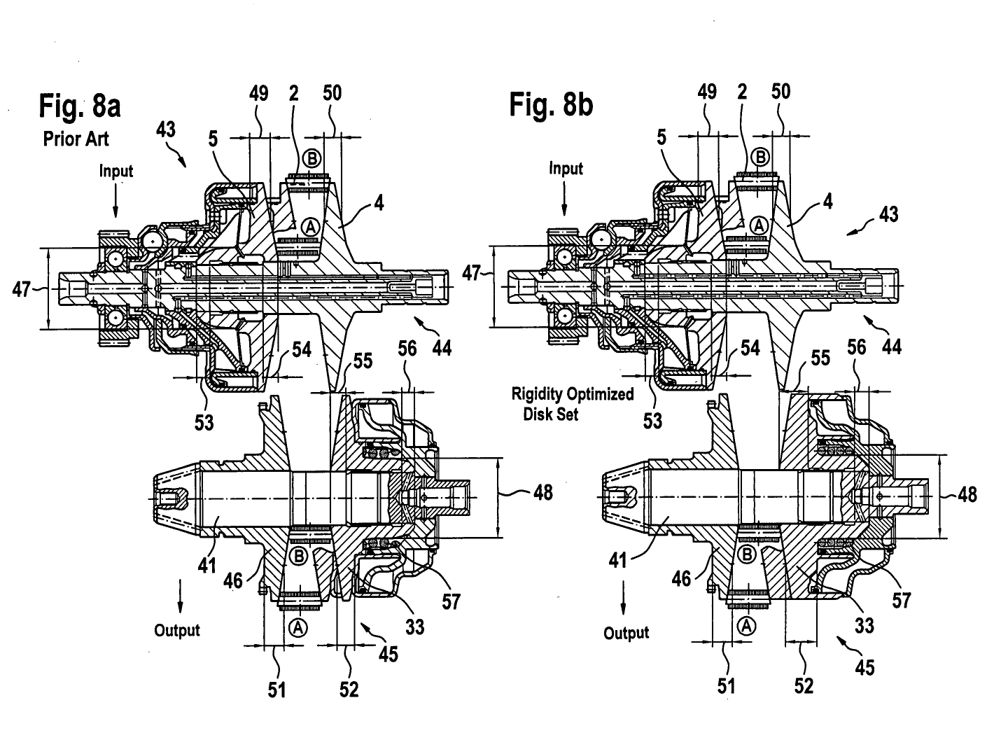

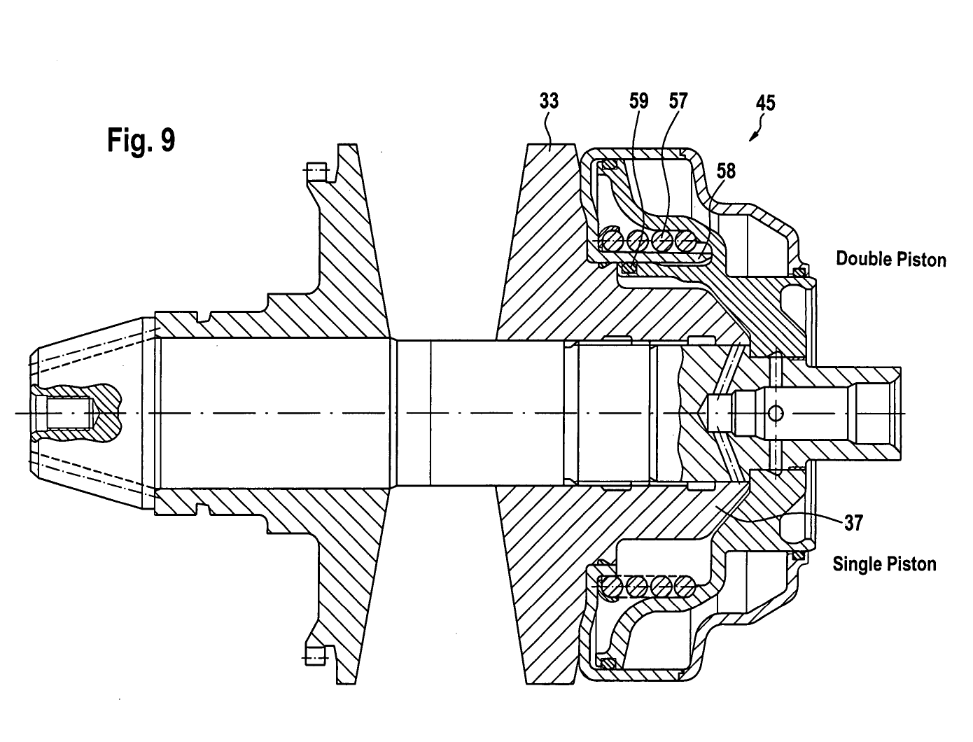

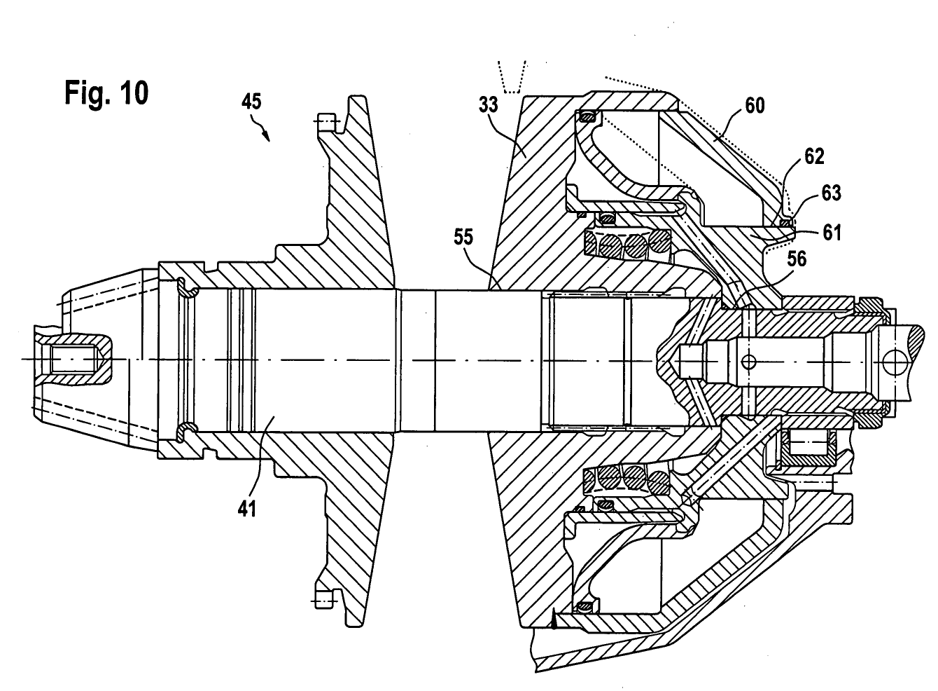

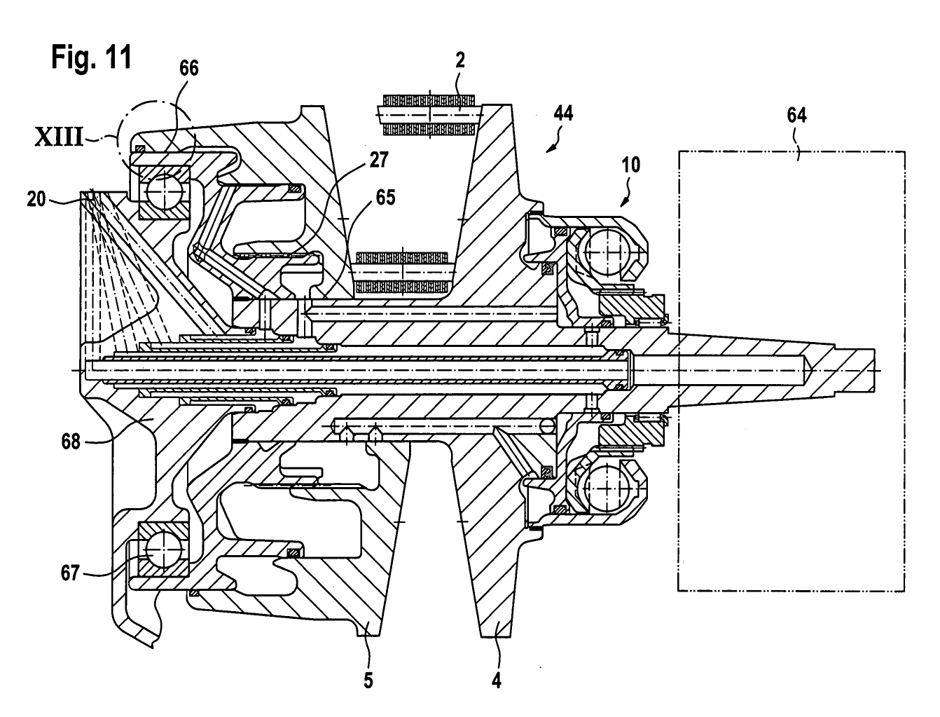

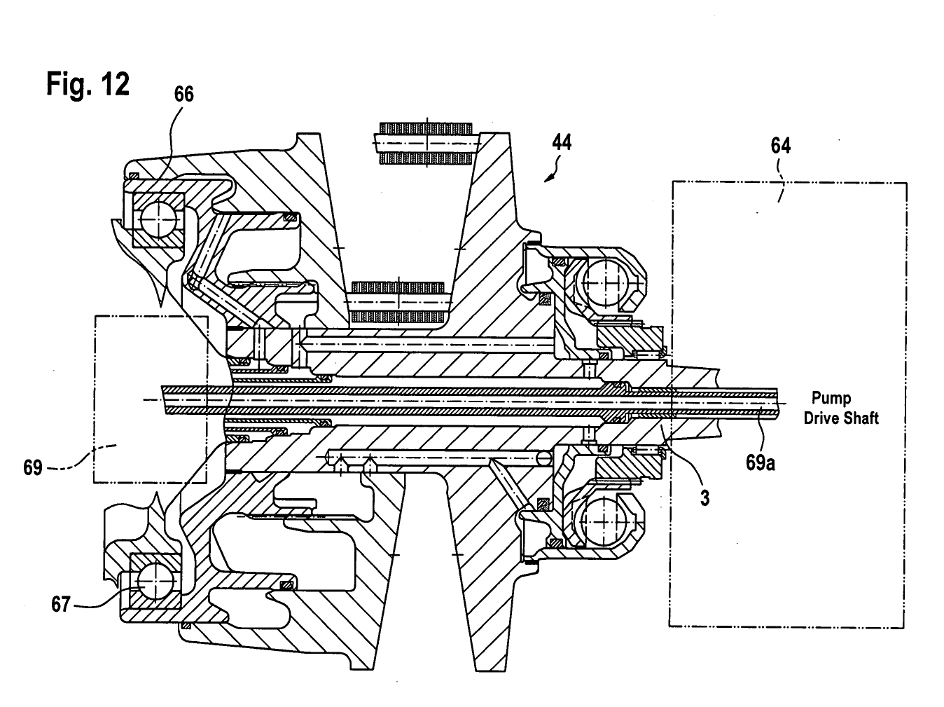

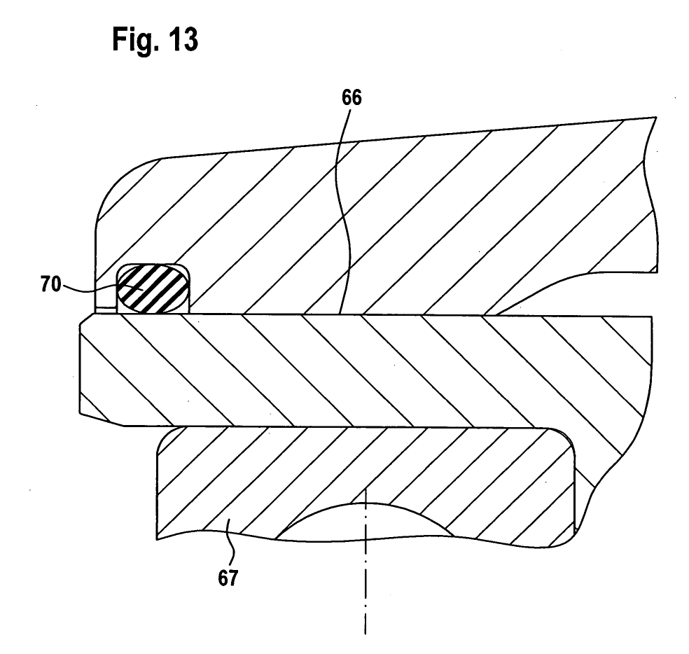

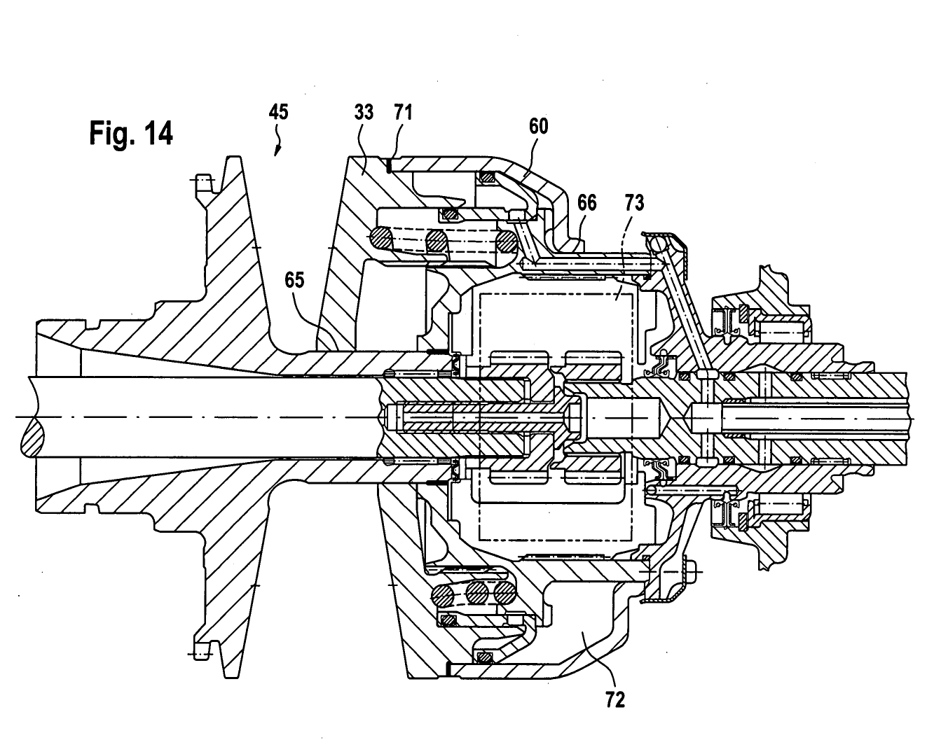

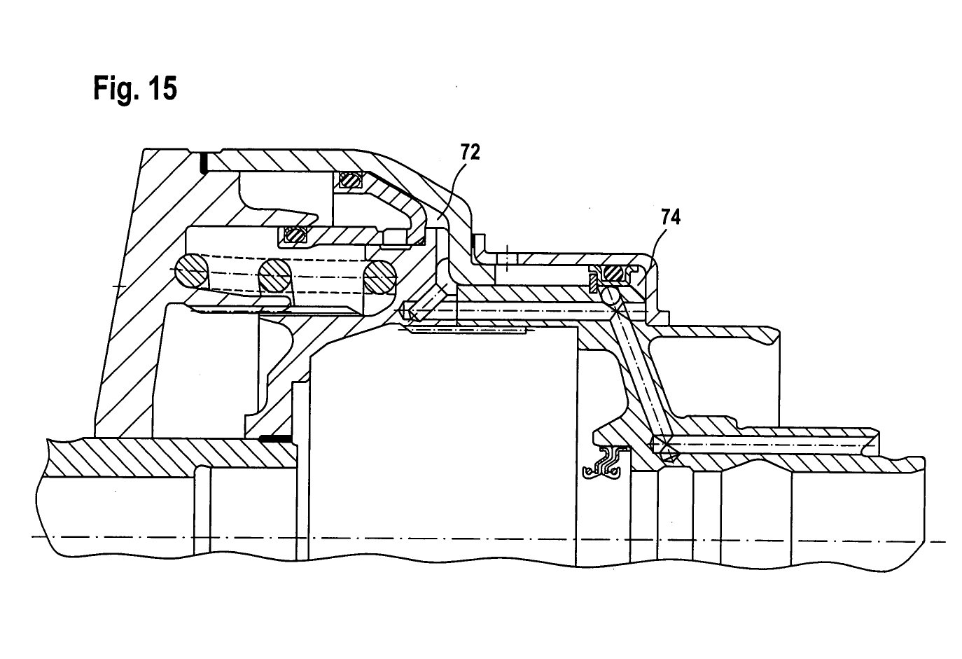

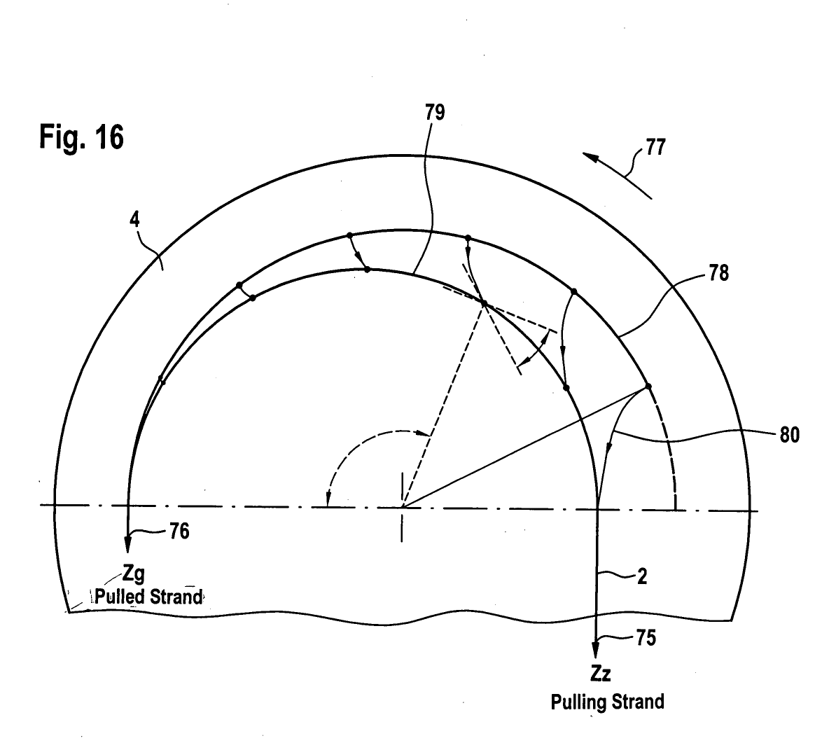

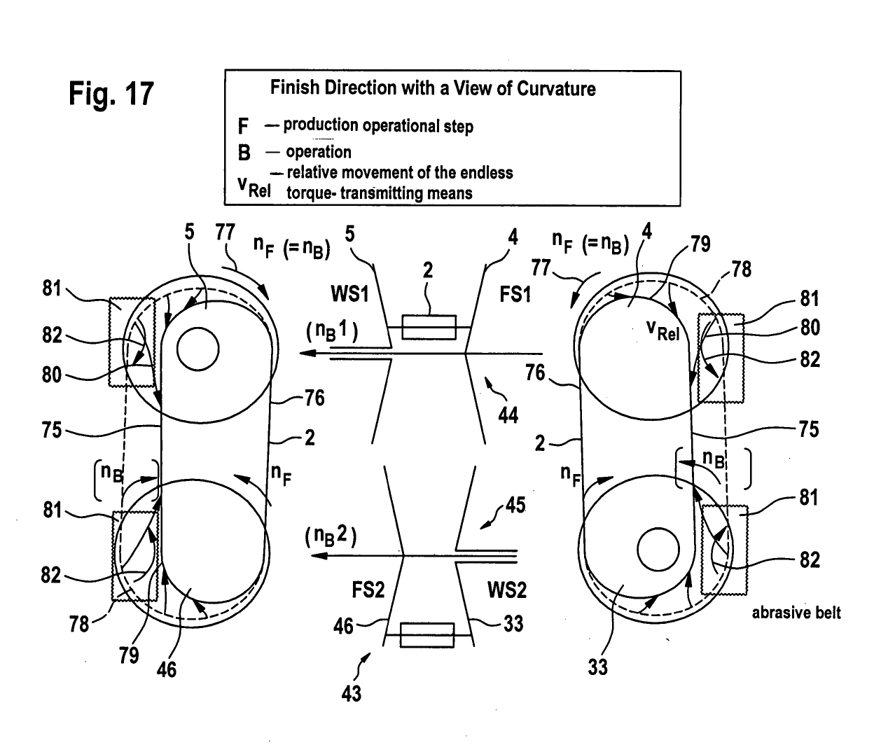

In FIG. 2, only the middle one of the three conduits 20 is configured in a form that is modified from FIG. 1. It is evident that bore 24, which forms the central conduit 20, and which is produced as a blind bore from the side shown on the right in FIGS. 1 and 2, is significantly shorter than in FIG. 1. Such blind bores are complex and expensive to produce and require a very high degree of precision in manufacturing. The expense of production and the requirements in terms of process reliability increase disproportionately with the length. Thus shortening a bore of that sort has a favorable effect on, for example, the production costs.

In the area of the floor of that bore 24 the lateral bore 25 branches off; there can be a plurality of those arranged around the circumference. In the case shown, that lateral bore 25 is shown as a radial bore; however, it can also be produced at a different angle as an inclined bore. Bore 25 penetrates the outer surface of shaft 3 at a place which is independent of the operating state, i.e., for example independent of the transmission ratio setting, in an area which is always covered by movable disk 5.

By shifting lateral bore 25 to the zone covered by movable disk 5, shaft 3 can be made axially shorter, enabling construction space to be saved. In addition, shortening shaft 3 can also result in reduced strain.

The mouth of the conduit or lateral bore 25 can be located for example in the area of the groove 26, which is adjacent to the centering surface 22 of the shaft. That can be particularly advantageous if the tooth system 27, which connects movable disk 5 to shaft 3 so that it can be shifted axially but is rotationally fixed, is subjected to heavy loads, for example by the transmission of torque.

But in many cases the load on the tooth system 27 will not be the most critical design criterion, so that the mouth of bore 25 can be placed in the area of that tooth system, as shown in FIG. 2. Placing lateral bore 25 within the toothed area 27 instead of in the groove 26 produces an advantage through the fact that a greater section modulus is present, which reduces the bending stress in the surface layer region. In addition, the polar moment of inertia is greater at that location, while the critical fiber, which is disturbed by lateral bore 25, remains at an approximately constant radius. That results in a significant reduction of the tensions in the critical area around the mouth of lateral bore 25 between the teeth of tooth system 27. The system of supplying with hydraulic fluid is identical in FIGS. 1 and 2, since pressure chambers 15 and 19 are connected to each other and movable disk 5 has connecting bores 28 which connect the area of the tooth system 27 with pressure chamber 19. In the figures, movable disk 5 is in its most extreme left position, which corresponds to the start-up transmission ratio or underdrive. If movable disk 5 is now shifted to the right in the direction of fixed disk 4, there is always part of the hollow space or of chamber 29 over the mouth of the lateral bore or of conduit 25, so that the necessary fluid supply is always ensured, just as in FIG. 1. Also as in FIG. 1, there are two shift states for pressure chamber 16, which depend on the axial position of movable disk 5. In the illustrated position the control bores 30 are free, so that the conduit 20 which is connected to them and is closed axially with a stopper 31, and the pressure chamber 16, which is connected to the latter through a conduit (not shown), are not pressurized or have only ambient pressure. If movable disk 5 is now moved toward fixed disk 4, it passes over control bores 30, so that starting at a certain distance chamber 29 comes to rest over the mouths of control bores 30. In chamber 29, however, a high pressure dependent on the torque prevails, which is then also conveyed through control bores 30 and conduit 20 into pressure chamber 16, so that high pressure is also present there. In that way two shift states are realized, which control the clamping force as a function of the transmission ratio.

In addition, in the FIG. 2 embodiment there is provided a disk spring 32 that moves movable disk 5 to a predetermined axial position when transmission 1 is not under pressure, enabling a transmission ratio of transmission 1 to be set which prevents excessive loads, for example when the motor vehicle is towed.

FIG. 3 includes two graphs that show the gradient of the coefficient of friction over a range of running or surface speed and as a function of the contact pressure. The running or surface speed is shown on the abscissa and the coefficient of friction on the ordinate. The dashed line is to be seen as a reference value, and represents a coefficient of friction, which can be, for example, μ=0.12. As can be seen from both figures, the coefficient of friction is a function of the running or surface speed, tending to decrease as the running or surface speed increases.

As explained earlier, with clutches, for example, a coefficient of friction that drops as the running or surface speed increases leads to grabbing, and hence to a decline in comfort. An effort should therefore be made to keep that decline in the coefficient of friction over the change of running or surface speed as small as possible.

The coefficient of friction gradient shown in FIG. 3 occurs at the place of contact between the rocker members of the chain and the contact surfaces of the disks that operate together with them. The chain, or endless torque-transmitting means, is under load both in the running direction, from the torque that is being transmitted, and also transversely to the running direction, primarily from the clamping force. That clamping force must be chosen so that the torque to be transmitted can be conveyed to the other set of disks with adequate reliability against slippage.

The spacing of the curves in the direction of the ordinate represents the scatter range of the coefficient of friction as a function of the clamping force or contact pressure. The bottom line represents a low contact pressure and the upper one in each case represents a higher contact pressure.

When comparing the former construction according to the upper graph and the embodiment according to the invention as shown in the lower graph, it is noticeable that at first the scatter range that is bounded by the two curves is smaller, resulting in a lesser dependence of the coefficient of friction on the contact pressure or clamping pressure existing at the time. Expressed in different terms, the embodiment according to the present invention (the lower graph) is less sensitive to changes in contact pressure.

It can also be seen from FIG. 3 that the curves in the lower graph are flatter, which means that the coefficient of friction is less dependent on the running or surface speed. Through that flatter, negative gradient of the coefficient of friction over the range of running or surface speed, a more stable behavior of the coefficient of friction is achieved. At the same time, it is less problematic if the curves are shifted quasi parallel from top to bottom or vice versa, than if their slope were to change, since any change in slope represents a greater dependency of the coefficient of friction on the running or surface speed.

Such a clearly defined pattern of the coefficient of friction over the range of running or surface speed and over the range of contact pressure, as shown in the lower graph of FIG. 3, results in a suppression of the vibration that is caused by the variation of the coefficient of friction of the steel-to-steel contact between the belt or chain and the conical disks. The vibration can be offset at the place where it develops, through the use of an appropriate oil with such a coefficient of friction variation.

The graphs in FIG. 4 are organized essentially like those in FIG. 3. They do not show the dependency on the oil used, but on the surface characteristics. What is shown in FIG. 3 with regard to interpretation and improvement also applies to FIG. 4; that is, the lower graph shows a significant improvement in the conditions.

The upper graph in FIG. 4 shows the conditions at a polished surface, while the lower graph in the figure shows the coefficient of friction as a function of the running or surface speed and the contact pressure with surface characteristic values according to the present invention. Those surface characteristic values are producible by a finishing process, for example, where the friction parameters have the correct variation and also retain it over a relatively long running time. For example, noise phenomena occur immediately with smoother surfaces, while with rougher surfaces they occur later, or in the most favorable case not at all. An improvement of that sort in regard to the noise behavior is also achievable by reducing the clamping force or contact pressure.

Investigations with simulations and measurements have shown that the vibration behavior, and hence the noise behavior, are influenced positively by an increased tilting stiffness of the axially movable disks, with that applying in particular, but not exclusively, in regard to the movable disk on the output side. In general it has turned out that an increased bending stiffness, whereby the opening of the conical disks when under load is reduced, especially of the set of conical disks on the output side, the vibration amplitude, which is significant in regard to the noise, is lessened. A comparable effect can be achieved through increased damping at that location.

FIGS. 5 and 6 each show a schematic profile of a movable disk, with only the upper half of the rotationally symmetrical profile being shown in each case.

FIG. 5 shows in each of the schematic exemplary embodiments a) through e) a stiffening of the disk itself. At the same time, FIGS. 5 and 6 each show schematically a part of the axially moving disk or movable disk 33 on the output side; comparable designs can also be carried over to the movable disk 5 on the input side.

The movable disk 33 shown in FIG. 5a has, in its area facing away from the endless torque-transmitting means 2, a plurality of radially-extending stiffening ribs 34 distributed circumferentially, which reduces displacement of the radially-outwardly-extending part of disk 33 when under an axial force, or in the most favorable case prevents it; thus it counteracts an enlargement of the axial spacing of the pair of disks.

Movable disk 33 according to FIG. 5b has a design in which the radially outwardly extending part of movable disk 33 is reinforced by having its wall thickness increase in the radially outward direction. That is achieved by an appropriate design of the contour of the disk facing away from endless torque-transmitting means 2. The course of that contour, which is shown in the drawing as even, or a wall of constant thickness, can also be modified so that the wall thickness increases in several steps.

To stiffen movable disk 33 in the axial direction, a stiffening collar can also be applied radially at the outside, as shown in FIG. 5c. FIG. 5d shows, in addition to stiffening collar 35 located radially at the outside, an additional stiffening collar 36 that is located further radially inward and thus can in that case also serve as a partition between two pressure chambers.

In FIGS. 5c and 5d, stiffening collars 35 and 36 are shown as separate parts or circular rings, which have to be connected to movable disk 33. FIG. 5e shows a possibility for constructing stiffening collar 35 and/or stiffening collar 36 in a single piece with movable disk 33, with the possibility of giving consideration to a production-friendly design in a beneficial way.

FIGS. 5f and 5g show a stiffening of the connection of the disk to the shaft. Here, first of all, hub 37 of movable disk 33 is connected to the radially outwardly extending part of movable disk 33 by means of a stiffening ring 38, so that a deformation of that area is at least reduced. Furthermore, there are again radial stiffening ribs 34, which are connected on one side to stiffening ring 38 and on the other side to hub 37 of movable disk 33.

FIGS. 6a through 6e show the principles of damping possibilities for the axially moving disk or movable disk 33 on the output side, which are also applicable, however, to the axially moving disk or movable disk 5 on the input side.

FIG. 6a shows first of all a subdivision of hub 37 into individual lamellae. That bundle of lamellae is pressed together by the clamping pressure that is applied through the hydraulic medium and thus produces a damping effect.

In FIG. 6b, in addition, stiffening collar 35 is constructed as a bundle of lamellae, which is again pressed together by the clamping pressure. According to FIG. 6c, stiffening collar 36, which is located radially further inwardly, can also be constructed as a bundle of lamellae; that stiffening collar 36 can again be utilized as a partition between different pressure chambers. Alternatively, in an embodiment in accordance with FIG. 6c the hub 37 can also be subdivided into individual lamellae.

FIGS. 6d and 6e both show springs 39, which increase the friction between the individual cylinders of lamellae through additional radial clamping pressure, which simultaneously increases the damping effect. It would also be possible in FIG. 6e to construct hub 37 as a bundle of lamellae.

FIGS. 6f and 6g show a different approach to a solution, which involves changing the direction of tilt of the movable disk. With the usual guidance of the movable disk by its radial inner region or by its hub 37, the radial outer region of that movable disk shows the greatest deflection in the direction of tilting. To counter that, it is possible in principle to guide the movable disk at the outside, so that its radially outer regions lie against the outer guide 40 and hence cannot deflect there. Tilting would then occur at the radially inner region of movable disk 33, against which countermeasures could again be taken as described above. In that case, care must be taken, however, to avoid jamming or clamping of movable disk 33 between the guides.

FIG. 7 schematically shows movable disk 33 on the output side; at the same time, comparable effects occur on movable disk 5 on the power input side. The statements made in regard to movable disk 33 on the output side thus also apply to movable disk 5 on the power input side; for the sake of clarity, the processes and features will be described below merely on the basis of movable disk 33.

Movable disk 33 consists of two main areas, namely a dished conical disk 42 and the neck of the conical disk or the hub 37. Movable disk 33 is mounted so that it is rotationally fixed but can be shifted axially on shaft 41 on the output side, and thus transmits the torque introduced by endless torque-transmitting means 2 (see FIGS. 8a and 8b) to the output, i.e., for example, through a differential gearbox and flange-mounted drive shafts, and ultimately to the drive wheels of the motor vehicle.

FIG. 7 shows two profiles of movable disk 33, not to scale, namely profile A in solid lines, which shows the non-deformed, unloaded condition, and on the other hand profile B in phantom lines, which represents the deformed condition that results under the influence of force F. It should be noted that the unloaded, non-deformed condition in accordance with profile A is rotationally symmetrical, as can be seen from the drawing.

The force illustrated by the arrow located at the top, radially outward region, is the reaction force of the endless torque-transmitting means to the sum of the clamping forces described above for torque transmission and those for adjusting the transmission ratio of the transmission. At the application point of the illustrated force F, and along an arc-shaped segment that extends over part of the circumference of movable disk 33, endless torque-transmitting means 2 is in contact with movable disk 33, while on the diametrically opposite side of the disk (shown below the axis of shaft 41) endless torque-transmitting means 2 (see FIG. 1) does not contact movable disk 33, since the endless torque-transmitting means extends in the direction of the complementary set of conical disks.

As can be seen from FIG. 7, the profile change from profile A to profile B results not only from a deformation of the dished surface of conical disk 42, but also from a tilting of the entire movable conical disk 33. If only a deformation of the dished surface of conical disk 42 occurred, profile A and profile B on the unloaded side shown below the shaft axis would be practically identical.

The illustration shows, however, that on the unloaded side the deformed profile B is deflected in the same direction as that of force F that is acting on it (toward the right in FIG. 7), while on the unloaded side below the shaft axis it is deflected in the direction opposite to force F (to the left in FIG. 7).

The deflection results from the tilting of the entire movable disk 33, since on the one hand the neck of the conical disk or the hub 37 also has only limited stiffness, and, on the other hand, because of the axial shiftability of the conical disk or movable disk 33, the latter cannot be guided along its entire length that interacts with shaft 41. In addition, the axial movability requires a certain guidance free play between hub 37 and shaft 41, which, however, on the other hand promotes tilting of movable disk 33. The greater the play, the more pronounced is the tilting.

Both the deformation and the tilting are produced by the bending moment resulting from force F, which circulates with respect to the particular conical disk, and which increases in proportion to the radius at which endless torque-transmitting means 2 is running (while the force remains the same).

Because of that tilting and the uneven deformation of movable disk 33, as well as the uneven load distribution within endless torque-transmitting means 2, when endless torque-transmitting means 2 runs through the loop on the conical disk a radial motion is imposed on it, whereupon the chain or endless torque-transmitting means 2 moves radially inward in the direction of shaft 41, yet also radially outward in other partial regions of the loop. Due to the load and the deformations, the resulting friction forces and friction paths increase greatly. That results in poorer efficiency and greater wear on the interacting surfaces. It has also been found that that is an excitation mechanism for frictional vibrations, which, in turn, can produce excitation of structure-borne noise.

FIGS. 8a and 8b show variable speed drive 43 with conical disk set 44 on the power input side and conical disk set 45 on the output side, with FIG. 8b showing a variable speed drive 43 that is better optimized for stiffness than is variable speed drive 43 in accordance with FIG. 8a.

Conical disk set 44 on the power input side has a fixed disk 4 and a movable disk 5, which are connected through a endless torque-transmitting means in the form of a plate-link chain 2 to the corresponding movable disk 33 and fixed disk 46 of disk set 45 on the output side.

Reference numerals 47 through 56 used in FIGS. 8a and 8b denote the following features:
47—outer diameter of movable disk neck, power input side;
48—outer diameter of movable disk neck, output side;
49—width of movable disk plate, power input side;
50—width of fixed disk plate, power input side;
51—width of fixed disk plate, output side;
52—width of movable disk plate, output side;
53—length of small slide seat, power input side;
54—length of large slide seat, power input side;
55—length of large slide seat, output side; and
56—length of small slide seat, output side.

In variable speed drive 43 in accordance with FIG. 8a, the movable disk outer diameters 47 and 48 on the power input side and output side are practically the same, i.e., they have comparable outer diameters and hence comparable strength. It can also be stated that the widths of the movable disk and fixed disk plates on the power input side and output side 49, 50, 51, and 52 are approximately comparable in size, so that the geometric form of the respective conical disks 4, 5, 33, and 46, and hence also their rigidity and strength, is of a comparable order of magnitude. The large and small slide seats 53, 54, 55, and 56 on the power input and output sides are also comparable in length, so that comparable geometric conditions also prevail in that respect, in particular in regard to the support of the respective movable disks on their associated shafts.

The variable speed drive 43 in accordance with FIG. 8b, optimized for stiffness, is designed differently. Movable disk neck outer diameter 48 on the output side is significantly greater than movable disk neck outer diameter 47 on the power input side, the neck outer diameter of the movable disk on the output side simultaneously being designed as the guide diameter for the compression spring 57 that is associated with it. Compression spring 57 is shown as cylindrical in FIG. 8b, whereas in accordance with FIG. 8a it can also have a narrow waist. A conical shape of compression spring 57 is also possible.

The enlarged movable disk neck outer diameter 48 on the output side results in Increased stiffness of movable disk 33 on the output side, since a greater polar moment of inertia or section modulus is achieved as a result.

Another result of the structural representation in accordance with FIG. 8b is that conical disk set 45 on the output side is significantly stiffer than conical disk set 44 on the power input side. A comparison shows that fixed disk plate width 51 on the output side is greater than fixed disk plate width 50 on the power input side. Furthermore, movable disk plate width 52 on the output side is substantially greater than movable disk plate width 49 on the power input side. The respective lengths of the large and small slide seats 55 and 56 on the output side are also substantially greater than the lengths of the corresponding slide seats of disk pair 44 on the power input side, which have the reference numerals 53 and 54.

That arrangement results in increased stiffness of disk set 45 on the output side compared to disk set 44 on the power input side, partly from the rigidity of conical disks 33 and 46 due to their more ample dimensioning. In addition, the better support due to the increased slide seat lengths 55 and 56 results in better protection against tilting under the loading from tension medium 2.

To further increase the tilting stiffness, it is possible to minimize the free play with which movable disk 33 is mounted on slide seats 55, 56 on the shaft, so that it is axially displaceable but rotationally fixed, in order to thereby also counter a tendency of movable disk 33 to tilt.

In summary, the following design elements contribute to optimizing the rigidity of variable speed drive 43:
disk set 45 on the output side is reinforced by the geometry of conical disks 33 and 46 compared to conical disk set 44 on the power input side;
movable disks 33 and 5 are reinforced compared to fixed disks 4 and 46;
slide seat lengths 55 and 56 on the output side are lengthened compared to slide seat lengths 54 and 53 on the power input side;
movable disk outer neck diameter 48 on the output side is increased compared to movable disk neck outer diameter 47 on the power input side;
the large slide seat 55 of movable disk 33 on the output side is designed so that it has the greatest possible guide length in underdrive position (with endless torque-transmitting means 2 running radially to the outside).

It would be possible in principle to modify the entire variable speed drive 43 accordingly, i.e., to provide it with more massive conical disks and increased slide seat lengths, etc., but limits are imposed, for example, by the available construction space and the weight of the transmission.

FIG. 9 shows two possible configurations of conical disk set 45 on the output side, with the lower half showing a disk set constructed in accordance with the single piston principle, while the upper half shows a disk set constructed in accordance with the dual piston principle, as described, for example, in DE 103 54 720.7.

In the dual piston principle, separate pistons are available for the clamping and the transmission ratio adjustment, whereas in the single piston principle only one piston/cylinder unit introduces the corresponding force into the disk set.

The fundamental construction of disk set 45 in accordance with FIG. 9 is as described earlier, in particular in connection with FIG. 8b. The explanation already given applies to the design in regard to optimizing for rigidity and strength.

Compared to the versions described so far, compression spring 57 here has a larger diameter, so that its point of application on movable disk 33 is radially farther outward. One of the advantages resulting from that arrangement is that more construction space is available to thicken up the conical disk neck or hub 37 or to design it with stronger geometry and increase its diameter. The resulting gain in strength was already described earlier. In the dual piston principle shown at the top of FIG. 9, that results in a modified arrangement of compression spring 57 to the effect that it is shifted from the radially inner pressure chamber into the radially outer pressure chamber. The sheet metal part 58 that supports compression spring 57 radially inwardly is firmly connected to movable disk 33, and its side facing away from spring 57 serves as a sealing trace for seal 59. However, that sealing trace can also be integrally formed with movable disk 33, as shown, for example, in FIG. 8b. That part, integrally formed with movable disk 33, would then, in turn, hold the radially inner portion of compression spring 57 with its radially outer region. With an inwardly lying compression spring 57, that part can form one sealing trace radially at the inside and one radially at the outside.

FIG. 10 shows additional configuration possibilities for conical disk set 45 on the output side, to which the earlier description also applies, in particular in regard to optimizing for stiffness. Movable disk 33 on the output side is first supported on shaft 41 by two slide seats 55 and 56 as described earlier. Compared to the versions shown so far, centrifugal oil cover 60 is of significantly thicker and more solid design, so that movable disk 33 is additionally supported on flange piece 61 through slide seat 62. If sealing should be necessary in the area of that slide seat 62, that can be accomplished by seal 63 (FIG. 10, above). Thus, movable disk 33 has three slide seats 55, 56, and 62 by which it is supported with respect to the shaft. Such support has much greater rigidity, so that such a configuration also contributes to solving the problem on which the invention is based.

FIG. 11 shows a schematic view of a set of conical disks 44 on the power input side, having a start-up element 64 shown schematically by a dash-dotted line, torque sensor 10, and the endless torque-transmitting means in the form of plate-link chain 2. The radial position of plate-link chain 2 is dependent on the size of the wedge-shaped gap, which is made larger or smaller between fixed disk 4 and movable disk 5 depending on the transmission ratio by moving movable disk 5 away from fixed disk 4 or axially toward it. The upper half of FIG. 11 shows the position of movable disk 5 that produces the largest possible transmission ratio of the transmission toward a slower speed (underdrive). To that end, the distance between fixed disk 4 and movable disk 5 is a maximum; that is, movable disk 5 is in its farthest left position in FIG. 11. In contrast, the lower half of the figure shows the maximum transmission ratio in the direction of fast (overdrive), where the space between fixed disk 4 and movable disk 5 is a minimum, so that plate-link chain 2 is running at the largest possible diameter. To that end, movable disk 5 is shown in its farthest right position.

Movable disk 5 is established so that it is rotationally fixed but axially movable with respect to fixed disk 4. That arrangement is achieved on the one hand by the teeth 27 and on the other hand by the two slide seats 65 and 66, the first slide seat 65 being located radially inward, while the second slide seat 66 is located in the radial outer area of movable disk 5, radially outside of bearing 67.

A comparison, particularly with FIG. 8a, shows that by shifting the second slide seat 66 radially outward, as shown in FIG. 11, axial construction space can be saved radially inward, and thus overall space. Part of the housing base structure 68, for example, can be located in that construction space, in which channels 20 can be accommodated that are used to supply fluid, for example, for adjusting the disk set 44, which is transmission-ratio-dependent.

Another advantage of locating second slide seat 66 radially outward is that movable disk 5 can be supported better against tilting, which increases the rigidity of the disk pair and makes it possible to avoid, or at least reduce, the disadvantages that might result, as already described earlier.

FIG. 12 shows schematically how a hydraulic pump 69, indicated by the dash-dotted line, can be arranged in the area radially inside of slide seat 66 and bearing 67. Hydraulic pump 69, in turn, is used to provide the pressurized hydraulic medium for moving and clamping the conical disk sets. Hydraulic pump 69 is driven for that purpose by means of a drive shaft 69a, which, in turn, is driven in the region of start-up element 64 and can be positioned coaxially in shaft 3 of conical disk set 44.

FIG. 13 shows an enlarged representation of the detail at XIII in FIG. 11. As can be seen from the overview in FIGS. 11 through 13, because of its positioning radially to the outside, the length of slide seat 66 does not determine the construction space, so that despite the larger supporting length of slide seat 66 it is possible to place seal 70 axially adjacent to the actual slide seat 66 or as an axial extension of slide seat 66, without critically shortening the length of slide seat 66. The relatively large length of slide seat 66 for its part has a favorable effect, for example, on the rigidity properties of the movable disk and hence of the entire variable speed drive. On the one hand, seal 70 is necessary because slide seat 66 must have a certain free play in order to ensure that it can be shifted axially, and on the other hand because on the side of slide seat 66 facing away from seal 70 a hydraulic pressure exists, which arises from adjustment and clamping of the conical disk, while on the side of slide seat 66 facing away from seal 70 it is practically ambient pressure that exists, resulting in a strong pressure differential.

FIG. 14 shows a conical disk set 45 on the output side, which, in turn, has a slide seat 65 lying radially inward, and a second slide seat 66 located radially outward. Second slide seat 66 is formed here using centrifugal oil cover 60, which is supported on the one hand by slide seat 66 at the base structure, and on the other hand is connected to movable disk 33 on the output side by means of welded seam 71. The oil in centrifugal oil chamber 72 brings about centrifugal oil compensation that is dependent on rotational speed. In the region radially inside of slide seat 66, which is formed by relocating slide seat 66 radially outwardly, it is possible to accommodate, for example, a distributor transmission 73 of an all-wheel-drive arrangement, which is shown schematically in FIG. 14 by the dash-dotted line. The torque introduced into distributor transmission 73 is divided by the latter between two output shafts, one of which can, for example, drive the front wheels and the other the rear wheels of the vehicle.

The embodiment shown in FIG. 15 corresponds essentially to the one in accordance with FIG. 14, there being an additional centrifugal oil chamber 74 formed here in addition to centrifugal oil chamber 72 for further rotational-speed-dependent centrifugal oil compensation.

FIG. 16 shows the top view in the axial direction of the dished or conical surface of fixed disk 4 on the power input side, and represented schematically on it is endless torque-transmitting means 2 in the form of a plate-link chain or its running trace on fixed disk 4. As a result of the relationship of tension strand 75 and slack strand 76 to fixed disk 4, in the illustration in FIG. 16, in the case where the latter is driven by the engine, i.e., when operating under tension, it moves counter-clockwise in the direction of arrow 77. That direction of motion as shown corresponds to the direction of rotation in operation. As can be seen from the illustration, the running trace of plate-link chain 2 on fixed disk 4 does not lie on the circular path 78, but on the spiral path 79. Because of the tensile force acting on tension strand 75, plate-link chain 2 is pulled to a path which is radially farther inward, while the wedge-shaped gap between the conical disks becomes larger, as shown and described earlier.

The top view in the axial direction of the dished or conical surface of fixed disk 46 on the output side, and represented schematically on it is endless torque-transmitting means 2 in the form of a plate-link chain or its running trace on fixed disk 46. As a result of the relationship of tension strand 75 and slack strand 76 to fixed disk 46, in the illustration in FIG. 16, in the case where the latter is driven from the engine by the chain, i.e., when operating under tension, it moves clockwise. That direction of motion as shown corresponds to the direction of rotation in operation. As can be seen from the illustration, the running trace of plate-link chain 2 on fixed disk 46 does not lie on the circular path 78, but on the spiral path 79. Because of the tensile force acting on tension strand 75, plate-link chain 2 is pulled to a path which is radially farther inward, while the wedge-shaped gap between the conical disks becomes larger, as shown and described earlier. Between the minimum wedge-shaped gap, approximately in the last third of the loop and the exit point, the wedge-shaped gap again narrows on account of the conical disk deformation, so that the chain again tends to wander outwardly (not shown).

Because of the load build-up or force build-up in chain 2 the latter is now drawn inward uniformly, which would establish a circular path lying farther inward radially, but growing in the tension direction of the tension strand, so that the illustrated spiral path 79 results. The direction of motion 80 of a chain link between circular path 78 and spiral path 79 here does not run straight, but in a curve, as illustrated, with the distance to be covered increasing with increasing proximity to the outgoing tension strand 75. That means that the relative motion between chain 2 and disk 4 increases, whereby the friction path increases greatly, which in turn can cause noises, as described earlier.

Because of the load build-up or force build-up in chain 2 the latter is now drawn inward uniformly, which would establish a circular path lying farther inward radially, but growing in the tension direction of the tension strand, so that the illustrated spiral path 79 results. The direction of motion 80 of a chain link between circular path 78 and spiral path 79 here does not run straight, but in a curve, as illustrated, with the distance to be covered increasing with increasing proximity to the incoming tension strand 75. That means that the relative motion between chain 2 and disk 4 increases, whereby the friction path increases greatly, which in turn can cause noises, as described earlier.

In addition to that spiral run, which is represented by spiral path 79, chain 2 makes an effort to slip or slide in the tension direction of the tension strand, i.e., practically in the circumferential direction of conical disk 4, in the direction of rotation 77 in operation. That too can for example result in noise problems.

FIG. 17 shows schematically the variable speed drive unit 43 of a belt-driven conical pulley transmission in accordance with the present invention. The input side conical disk set 44 is connected to output side conical disk set 45 through endless torque-transmitting means or plate-link chain 2 to transmit torque. Input side conical disk set 44 on the power input side has fixed disk 4 and movable disk 5, while the output side conical disk set includes fixed disk 46 and movable disk 33.

In the middle of FIG. 17 a cross section through variable speed drive unit 43 is shown, while to the left of that section view the input-side movable disk 5 and the output side fixed disk 46 are shown in a top view of the curvature, i.e., in practice from the viewpoint of endless torque-transmitting means 2. To the right of the detail is a corresponding view of input side fixed disk 4 and output side movable disk 33. In addition, both top views show plate-link chain 2 and its running trace. The direction of rotation of the respective conical disks in operation is identified by arrow 77, and additionally with the designation n_{B}. A combined examination with FIG. 16 and the accompanying description again produces an illustration of the spiral trace of plate-link chain 2. The relative motion of the chain in operation, in particular in regard to the direction of motion 80, is covered by the description in principle already given in connection with FIG. 16.

In the final or finish processing of the individual conical disks, the respective conical disk is first set in rotation. An abrasive substance or abrasive belt 81 is then pressed against the rotating conical disk, as shown in connection with movable disk 33 on the output side, until the desired surface roughness is reached, which can lie for example in the range between R_{z} 1.5 to 5.5.

The direction of rotation of the respective conical disk is set so that the direction of motion 82 of abrasive belt 81 relative to the running surface of the conical disk is similar in direction to the motion of the endless torque-transmitting means 2 relative to the running surface in later operation.

To achieve that, the following applies to the respective positions shown for abrasive belt 81:

For movable disk 5 and fixed disk 4 of conical disk set 44 on the power input side, the direction of rotation during production, i.e., during finishing, is identical to that during operation.

When producing conical disk set 45 on the output side, the direction of rotation of fixed disk 46 and of movable disk 33 is opposite to that during operation.

The result of that is that abrasive belt 81 moves relative to the respective conical disk with reference to the tangential direction sense in the same way as plate-link chain 2 moves later when in operation in its movement 80 from the circular path 78 to the spiral path 79.

Some of the abraded material sticks to abrasive belt 81, so that provision must be made for unused sections of the abrasive belt to be moved into position. That “readjusting” of the abrasive belt can also occur continuously or timed in the direction of motion 82.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A belt-driven conical-pulley transmission comprising: pairs of input side and output side conical disks, each disk pair including an axially fixed disk and an axially movable disk that are arranged on an input shaft and on an output shaft, respectively;
an endless torque-transmitting means extending between and passing around the disk pairs for transmitting torque between the input and output shafts, wherein the natural frequency of a strand of the endless torque-transmitting means is permanently adjusted.

2. A belt-driven conical pulley transmission in accordance with claim 1, wherein the natural frequency adjustment takes place by modulating a contact pressure imposed on the endless torque-transmitting means by the conical disks to provide a modulated strand frequency.

3. A belt-driven conical pulley transmission in accordance with claim 2, wherein the modulated strand frequency falls outside the strand natural frequency.

4. A belt-driven conical pulley transmission in accordance with claim 2, wherein the modulated frequency is lower than the strand natural frequency.

5. A belt-driven conical pulley transmission in accordance with claim 1, wherein the adjustment of the strand natural frequency is effected by a synchronous modulation of a contact pressure imposed on the endless torque-transmitting means by the input side and output side conical disk pairs.

6. A belt-driven conical pulley transmission in accordance with claim 2, wherein at least one of the modulated frequency and a modulated strand amplitude of vibration is sufficiently high that an adjustment gradient of the strand natural frequency prevents vibration of the strand when passing through an excitation frequency.

7. A method for operating a belt-driven conical pulley transmission, comprising the steps of: passing an endless torque-transmitting means between and around pairs of conical disks for transmitting torque between transmission input and output shafts; and is permanently adjusting a natural frequency of a strand of the endless torque-transmitting means.

8. A motor vehicle comprising: a drive train with a transmission having pairs of input side and output side conical disks, each disk pair including an axially fixed disk and an axially movable disk that are arranged on an input shaft and on an output shaft, respectively; an endless torque-transmitting means extending between and passing around the disk pairs for transmitting torque between the input and output shafts, wherein the natural frequency of a strand of the endless torque-transmitting means is permanently adjusted.
